(19) United States
(12) Patent Application Publication
(10) Pub. No.: US 2015/0281255 A1
(43) Pub. Date: Oct. 1, 2015

(54) TRANSMISSION APPARATUS, CONTROL METHOD FOR THE SAME, AND NON-TRANSITORY COMPUTER-READABLE STORAGE MEDIUM

(71) Applicant: CANON KABUSHIKI KAISHA, Tokyo (JP)

(72) Inventor: Ryo Watanabe, Tokyo (JP)

(21) Appl. No.: 14/659,173

(22) Filed: Mar. 16, 2015

(30) Foreign Application Priority Data
Mar. 26, 2014 (JP) 2014-064348

(51) Int. Cl. H04L 29/06; H04L 29/08

(52) U.S. Cl. CPC H04L 63/123; H04L 67/32

(57) ABSTRACT

A transmission apparatus having a display unit decides whether a receiving apparatus supports predetermined copyright protection technology, sets, with respect to an image that is displayed on the display unit, a scope of the image to serve as a target for copyright protection, determines a scope of the image to serve as a target for transmission, based on the scope set as a target for copyright protection, in a case where it is decided that the receiving apparatus does not support the predetermined copyright protection technology, and transmits an image of the determined scope as a target for transmission to the receiving apparatus.

### BACKGROUND OF THE INVENTION

1. Field of the Invention

The present invention relates to a transmission apparatus, a control method for the same, and a non-transitory computer-readable storage medium, and more particularly to technology suitable for when transmitting video content that is partly copyright protected via a network to a receiving apparatus that does not support copyright protection technology.

2. Description of the Related Art

In recent years, technology for wirelessly mirroring display screens has been standardized by Wi-Fi Miracast and the like. Mirroring is technology for sharing the display screen of a transmission apparatus, by transmitting the screen to a receiving apparatus via a network. Also, there is technology that implements copyright protection for preventing video content (hereinafter, content) from being unnecessarily copied or played, such as High-bandwidth Digital Content Protection (HDCP) technology, for example.

Also, there is technology that allows the transmission apparatus to notify a device on the receiving side that content will not be transmitted, in the case where the content is protected by copyright and cannot be output (Japanese Patent Laid-Open No. 2005-25270). Also, technology that allows a transmission apparatus that has judged that a screen that is being mirrored has changed to being copyright protected to automatically disconnect mirroring communication during mirroring to a receiving apparatus that does not support copyright protection is known.

There is a problem in that technology disclosed in Japanese Patent Laid-Open No. 2005-25270 is not applicable to transmission technology that does not hold consistent copyright protection information, such as mirroring. Also, with technology that disconnects mirroring communication automatically, the screen of the transmission apparatus shifts to a screen that does not require copyright protection after communication has been disconnected, and complicated mirroring reconnection processing needed to be performed in the case where the transmission apparatus wants to resume mirroring.

### SUMMARY OF THE INVENTION

The present invention was made in view of the above problems, and provides technology for implementing efficient mirroring without requiring complicated processing.

According to one aspect of the present invention, there is provided an transmission apparatus comprises: a display unit; a decision unit configured to decide whether a receiving apparatus supports predetermined copyright protection technology; a setting unit configured to set, with respect to an image that is displayed on the display unit, a scope of the image to serve as a target for copyright protection; a determination unit configured to determine a scope of the image to serve as a target for transmission, based on the scope set as a target for copyright protection by the setting unit, in a case where it is decided by the decision unit that the receiving apparatus does not support the predetermined copyright protection technology; and a transmission unit configured to transmit an image of the scope determined by the determination unit as a target for transmission to the receiving apparatus.

Further features of the present invention will become apparent from the following description of exemplary embodiments (with reference to the attached drawings).

### BRIEF DESCRIPTION OF THE DRAWINGS

FIG. 1 is a diagram showing a mode of connection of a transmission apparatus 100 and a receiving apparatus 200 according to Embodiments 1 and 2.

FIG. 2 is a block diagram showing an exemplary internal configuration of the transmission apparatus 100 according to Embodiments 1 and 2.

FIG. 3 is a diagram showing exemplary functional blocks of the transmission apparatus 100 according to Embodiments 1 and 2.

FIG. 4 shows an exemplary image that is displayed on a display unit 102 of the transmission apparatus 100 according to Embodiments 1 and 2.

FIG. 5 is a block diagram showing an exemplary internal configuration of the receiving apparatus 200 according to Embodiments 1 and 2.

FIG. 6 is a diagram showing exemplary functional blocks of the receiving apparatus 200 according to Embodiments 1 and 2.

FIG. 7 is a flowchart showing operations of the transmission apparatus 100 in Embodiment 1.

FIG. 8 is a diagram showing a processing sequence of the transmission apparatus 100 and the receiving apparatus 200 according to Embodiments 1 and 2.

FIG. 9 is a diagram showing a processing sequence of the transmission apparatus 100 according to Embodiment 1.

FIG. 10 is a diagram showing an exemplary detailed sequence of steps S143 and S243 in FIG. 9.

FIG. 11 is a flowchart showing operations of the transmission apparatus 100 according to Embodiment 2.

FIG. 12 is a diagram showing an exemplary image that is transmitted from the transmission apparatus 100 to the receiving apparatus 200 according to Embodiment 2.

FIG. 13 is a diagram showing a processing sequence of the transmission apparatus 100 according to Embodiment 2.

### DESCRIPTION OF THE EMBODIMENTS

Hereinafter, the present invention will be described in detail based on embodiments, with reference to the accompanying drawings. Note that the configurations that are shown in the following embodiments are merely intended as examples, and the present invention is not limited to the illustrated configurations.

### Embodiment 1

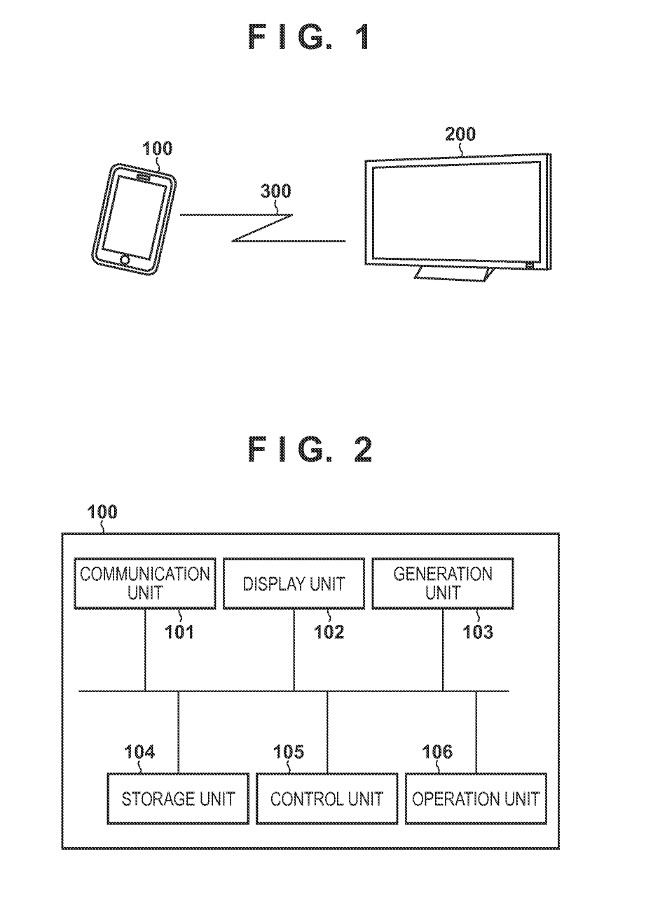

FIG. 1 is a diagram showing the mode of connection of a transmission apparatus 100 and a receiving apparatus 200 according to Embodiment 1 of the present invention. The transmission apparatus 100 and the receiving apparatus 200 are mutually connected via a network 300, and screen sharing is possible by transmitting an image displayed on the transmission apparatus to the receiving apparatus 200.

The transmission apparatus 100 starts, suspends and ends transmission of image data, in accordance with image transmission requests that are transmitted from the receiving apparatus 200 via the network 300. Specific examples of the transmission apparatus 100 include a camera, a video camera, a smart phone, a mobile phone, and a PC. However, the transmission apparatus 100 is not limited thereto and may be any device that satisfies later-discussed hardware configurations and module configurations.

The network 300 is the wireless Local Area Network (LAN) serving as a home network, for example. Note that, in the present embodiment, the home network is envisioned to be a wireless LAN conforming to the IEEE 802.11 series of standards, but is not limited thereto, and may be a wired LAN, a Wide Area Network (WAN), an ad hoc network, Bluetooth™, Zigbee™, UWB or the like.

On the other hand, the receiving apparatus 200 receives and displays image data that is transmitted from the transmission apparatus 100 via the network 300. Specific examples of the receiving apparatus 200 include a smart phone, a mobile phone, a PC, a television, and a projector. Also, one or a plurality of receiving apparatuses 200 may be connected to the network 300.

First, the configuration of the transmission apparatus 100 will be described. FIG. 2 is a block diagram showing an exemplary internal configuration of the transmission apparatus 100 according to the present embodiment. A communication unit 101 performs wireless LAN communication with the receiving apparatus 200, and realizes transmission and reception of information. A display unit 102 fulfills an external output function of the transmission apparatus 100. Specific examples include the liquid crystal screen of a digital camera, the liquid crystal screen of a smart phone, and the display of a PC. A generation unit 103 generates screens that are displayed on the display unit 102 as screen data that can be transmitted to the receiving apparatus 200, for example.

A storage unit 104 stores images generated by the generation unit 103. Also, in the case where a later-discussed control unit 105 incorporates a processor such as a Central Processing Unit (CPU), the storage unit 104 stores programs to be executed by the processor. Furthermore, in the case where the later-discussed control unit 105 incorporates a processor, the storage unit 104 is used for temporarily saving parameters that are used when the processor executes a program. The storage unit 104 is constituted by a ROM, a RAM, or the like, for example. A removable medium may also be used as the storage unit 104. Also, the storage unit 104 may be constituted in part or entirely by an external storage device. Also, the storage unit 104 may be constituted by a plurality of recording media.

The control unit 105 controls the operations of the constituent elements of the transmission apparatus 100 shown in FIG. 2. The control unit 105 can, for example, be constituted by a processor such as a CPU. In the case where the control unit 105 is constituted by a processor, the control unit 105 controls the operations of the constituent elements of the transmission apparatus 100 shown in FIG. 2, by reading out and executing programs stored in the storage unit 104. An operation unit 106 accepts operations on the transmission apparatus 100 that are performed by a user of the transmission apparatus 100. An operation on the transmission apparatus 100 by the user is input to the control unit 105, and operations of the transmission apparatus 100 are determined according to the user operation.

Note that the transmission apparatus 100 according to the present embodiment transmits images displayed on the display unit 102 to the receiving apparatus 200, but is not limited thereto. For example, the transmission apparatus 100 is able to generate video content that consists of a group of images displayed on the display unit 102, and can also transmit the video content to a receiving apparatus. Note that although the transmission apparatus has other constituent elements apart from those described above, description thereof is omitted because these other constituent elements are not a main focus of the present invention.

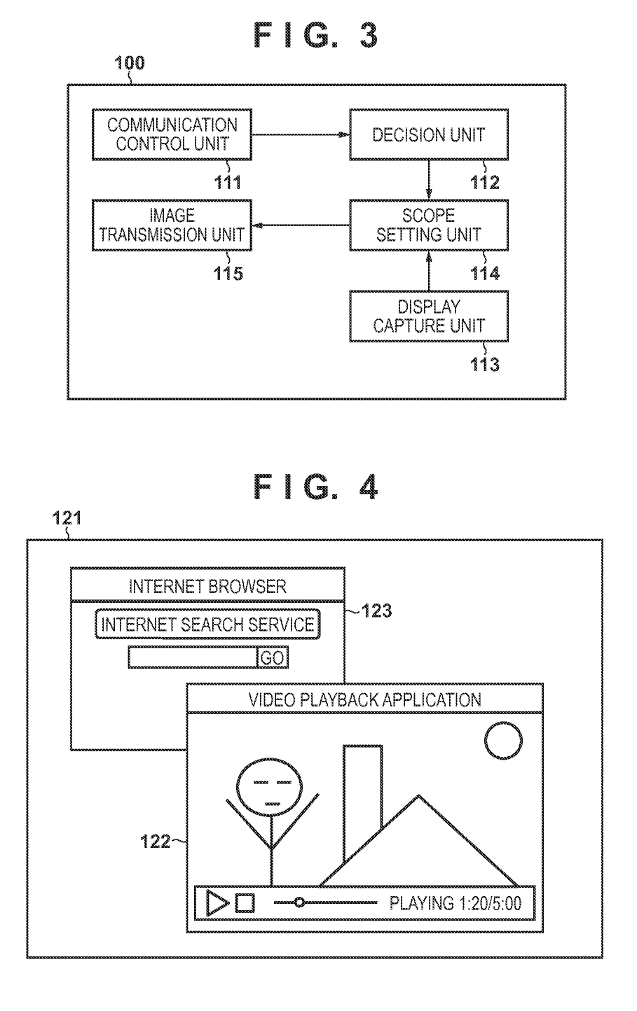

FIG. 3 is a diagram showing exemplary functional blocks of the transmission apparatus 100. The constituent elements shown in FIG. 3 represent functional modules that are executed by the control unit 105 controlling the respective constituent elements of the transmission apparatus 100. Some or all of the constituent elements shown in FIG. 3 may be executed by hardware that is independent of the control unit 105.

A communication control unit 111 controls communication with the receiving apparatus 200. The communication control unit 111 establishes a wireless communication connection with the receiving apparatus 200. The communication control unit 111 receives, from the receiving apparatus 200, information on images that the receiving apparatus 200 is able to receive. Here, the information on images can include at least one of the spatial size of images, the transfer amount of images, the transfer frequency of images, the encryption method of images, the decryption method of images, the playback method of images, and information on audio accompanying images. The communication control unit 111 transmits, to the receiving apparatus 200, information on images to be transmitted to the receiving apparatus 200. The information on images that is transmitted by the communication control unit 111 includes a method that can be decrypted by the receiving apparatus 200. Also, the communication control unit 111 notifies a later-discussed decision unit 112 of the method that can be decrypted by the receiving apparatus 200.

At the time of image transmission, the communication control unit 111 transmits and receives control information on the image transmission to and from the receiving apparatus 200. Here, control information on image transmission can include at least one of an image transmission start request, start OK, a suspend request, suspend OK, an end request, and end OK. Also, control information on image transmission can include a transmission request and request OK in relation to an image transmission start request, a suspend request or an end request. In the present embodiment, the communication control unit 111 uses Real Time Streaming Protocol (RTSP) as a data transmission control protocol after a wireless communication connection is established with the receiving apparatus 200. Note that RTSP is a protocol for controlling streaming standardized by RFC 2326, and Transmission Control Protocol (TCP) is used as a low level transport protocol.

The decision unit 112 decides whether the receiving apparatus 200 is a decryption apparatus that supports copyright protection technology, based on the method that can be decrypted by the receiving apparatus 200 that is notified of from the communication control unit 111. Here, copyright protection technology is technology for encrypting data in order to implement copyright protection, or technology for decrypting encrypted data. A decryption apparatus that supports copyright protection technology decrypts encrypted data that is received with a predetermined algorithm, using a decryption key acquired in advance. In the present embodiment, High-bandwidth Digital Content Protection (HDCP) is used as copyright protection technology.

A display capture unit 113 captures an image to be displayed on the display unit 102, and outputs the image to a later-discussed scope setting unit 114. The display capture unit 113 also outputs information relating to currently displayed video content or information relating to a currently displayed application to the later-discussed scope setting unit 114 together with the image. Here, information relating to video content includes position information on the area in which the video content is displayed, and information relating to copyright protection implemented on the video content. Also, information relating to an application includes position information on an area in which the application is displayed, and an ID or name that can identify the application.

The scope setting unit 114 sets a scope, of the entire image, to which copyright protection is to be applied, based on the image and the information input from the display capture unit 113, and outputs the set scope to a later-discussed image transmission unit 115 together with the input image. The scope setting unit 114 sets the copyright protection application scope to null, when it is decided by the decision unit 112 that the receiving apparatus 200 supports HDCP. Note that when it is decided by the decision unit 112 that the receiving apparatus 200 supports HDCP, copyright protection processing of the image is executed by the later-discussed image transmission unit 115. The scope setting unit 114 sets the copyright protection application scope, when it is decided by the decision unit 112 that the receiving apparatus 200 does not support HDCP.

The scope setting unit 114 sets the entire input image as the copyright protection application scope, when the input image includes an object that is to be copyright protected. When some form of copyright protection is implemented on video content that is being displayed, the scope setting unit 114 decides that the content is an object that is to be copyright protected. Also, the scope setting unit 114 holds, for example, an authorization list containing applications that do need copyright protection. When an application that has been run and is being displayed is not included in the authorization list, the scope setting unit 114 decides, for example, that the application is an object that is to be copyright protected. The authorization list may be held in the receiving apparatus 200 in advance, and may be updated when a user operation is performed or when an application is added or updated.

The image transmission unit 115 determines a transmission scope of an image input from the scope setting unit 114, based on the copyright protection application scope of the image, and transmits an image of this transmission scope to the receiving apparatus 200. The image transmission unit 115 does not transmit an image if a copyright protection application scope is set for the image. Note that the image transmission unit 115 may be configured to not transmit an image in the case where the entire image is set as the copyright protection application scope. The image transmission unit 115 transmits an image if a copyright protection application scope is not set for the image. The image transmission unit 115 encrypts the image before image transmission, in accordance with the information (method decryptable by the receiving apparatus 200, etc.) on the image transmitted to the receiving apparatus 200 by the communication control unit 111 in advance. In the present embodiment, the Real-time Transport Protocol (RTP) is used in image transmission. Note that RTP is a protocol standardized by Internet Engineering Task Force (IETF) in RFC 3550 for transmitting and receiving multimedia data such as video and audio in real time via a network, and User Diagram Protocol (UDP), HTTP, Hypertext Transfer Protocol Secure (HTTPS) or TCP can be utilized as the low level transport protocol.

Note that in the case where there are a plurality of receiving apparatuses 200 and the transmission apparatus 100 performs multicasting, transmission to one receiving apparatus 200 is started by causing the receiving apparatus 200 to join a multicast group. Note that in the case where there are a plurality of receiving apparatuses 200 and a scope, of the entire image, to which copyright protection is to be applied has been determined with respect to a specific receiving apparatus 200, transmission to this receiving apparatus 200 is controlled by causing this receiving apparatus 200 to resign from the multicast group.

FIG. 4 shows an exemplary image that is displayed on the display unit 102 by the transmission apparatus 100. An area 121 shows the entire area of the image that is displayed on the display unit 102 by the transmission apparatus 100. An area 122 is a portion of the image that is displayed on the display unit 102 by the transmission apparatus 100. The area 122 is an area in which a video playback application currently running on the transmission apparatus 100 is displayed. The area 122 may or may not include the portion that reads “Video playback application”. In the area 122, a part that is 1 minute 20 seconds into the video content is being played. An area 123 is a portion of the image that is displayed on the display unit 102 by the transmission apparatus 100. The area 123 is an area in which an Internet browser application currently running on the transmission apparatus 100 is displayed. For example, the scope setting unit 114 sets the area 121, which is the entire image, as the copyright protection application scope, when the video content that is currently displayed by the video playback application currently displayed in the area 122 is copyright protected. For example, the scope setting unit 114 sets the area 121, which is the entire image, as the copyright protection application scope, when the Internet browser application currently displayed in the area 123 is not included in the authorization list. The configuration of the transmission apparatus 100 is as described above.

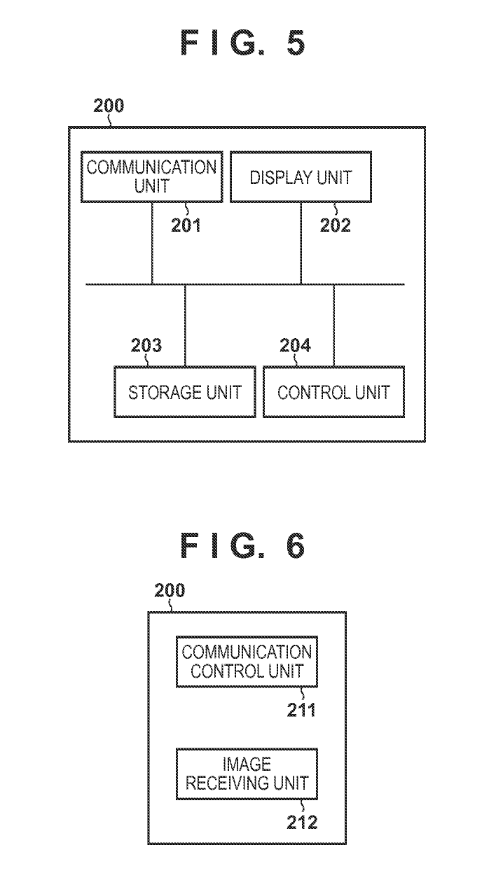

Next, the configuration of the receiving apparatus 200 will be described. FIG. 5 is a block diagram showing an exemplary internal configuration of the receiving apparatus 200 according to the present embodiment. A communication unit 201 performs wireless LAN communication with the transmission apparatus 100, and realizes transmission and reception of information. A display unit 202 fulfills an external output function of the receiving apparatus 200. Specific examples include the liquid crystal display of a digital camera, the liquid crystal display of a smart phone, and the display of a PC. The display unit 202 displays images that are acquired via the communication unit 201.

A storage unit 203 stores images acquired by the communication unit 201. Also, in the case where a later-discussed control unit 204 incorporates a processor such as a Central Processing Unit (CPU), the storage unit 203 stores programs to be executed by the processor. Furthermore, in the case where the later-discussed control unit 204 incorporates a processor, the storage unit 203 is used in order to temporarily save parameters that are used when the processor executes a program. The storage unit 203 is constituted by a ROM, a RAM or the like, for example. A removable medium may also be used as the storage unit 203. Also, the storage unit 203 may be constituted in part or entirely by an external storage device. Also, the storage unit 203 may be constituted by a plurality of recording media.

The control unit 204 controls the operations of the constituent elements of the receiving apparatus 200 shown in FIG. 5. The control unit 204 can, for example, be constituted by a processor such as a CPU. In the case where the control unit 204 is constituted by a processor, the control unit 204 controls the operations of the constituent elements of the receiving apparatus 200 shown in FIG. 5, by reading out and executing programs stored in the storage unit 203. Note that although the receiving apparatus has other constituent elements apart from those described above, description thereof is omitted because these other constituent elements are not a main focus of the present invention.

FIG. 6 is a diagram showing exemplary functional blocks of the receiving apparatus 200. The constituent elements shown in FIG. 6 represent functional modules that are executed by the control unit 204 controlling the respective constituent elements of the receiving apparatus 200. Some or all of the constituent elements of FIG. 6 may be executed by hardware that is independent of the control unit 204.

A communication control unit 211 controls communication with the transmission apparatus 100. The communication control unit 211 establishes a wireless communication connection with the transmission apparatus 100. The communication control unit 211 transmits, to the transmission apparatus 100, information on images that the receiving apparatus 200 is able to receive. Here, the information on images can include at least one of the spatial size of the image, the transfer amount of the image, the transfer frequency of the image, the encryption method of the image, the playback method of the image, and information on audio accompanying the image. Also, the communication control unit 211 receives, from the transmission apparatus 100, information on images to be transmitted by the transmission apparatus 100. The information on images that is received by the communication control unit 211 includes a method that can be decrypted by the receiving apparatus 200.

At the time of image reception, the communication control unit 211 transmits and receives control information on the image transmission to and from the transmission apparatus 100. Here, control information on image transmission can include at least one of an image transmission start request, start OK, a suspend request, suspend OK, an end request, and end OK. Also, control information on image transmission can include a transmission request and request OK in relation to an image transmission start request, a suspend request or an end request. In the present embodiment, the communication control unit 211 uses Real Time Streaming Protocol (RTSP) as a communication protocol after a wireless communication connection is established with the transmission apparatus 100. An image receiving unit 212 receives the image that is transmitted from the transmission apparatus 100, and displays the image on the display unit 202. Image reception is realized using the Real-time Transport Protocol (RTP). The configuration of the receiving apparatus 200 is as described above.

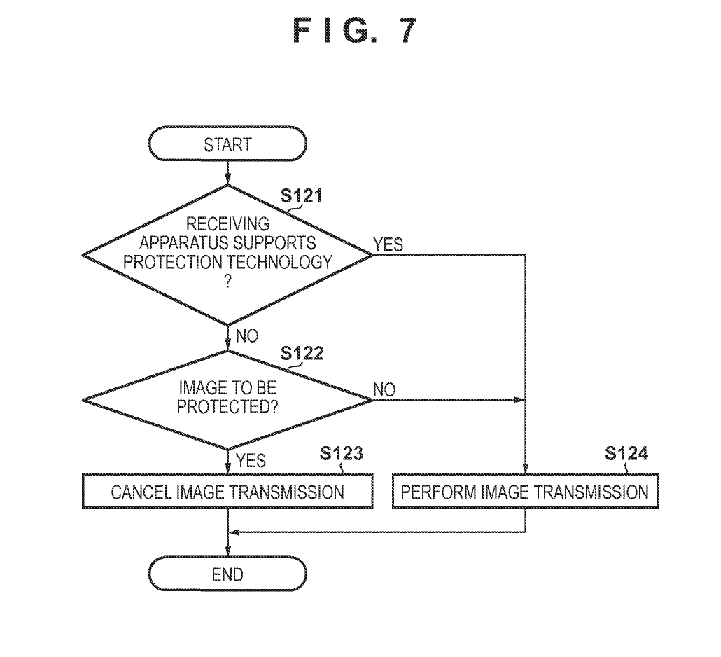

FIG. 7 is a diagram showing an exemplary flowchart of the transmission apparatus 100 according to the present embodiment determining whether to transmit an image. The steps shown in FIG. 7 are processed by the control unit 105 of the transmission apparatus 100 executing a program stored in the storage unit 104. First, at step S121, the decision unit 112 of the transmission apparatus 100 decides whether the receiving apparatus 200 is a decryption apparatus that supports HDCP. If the receiving apparatus is a decryption apparatus that supports HDCP, the processing proceeds to step S124. If the receiving apparatus is not a decryption apparatus that supports HDCP, the processing proceeds to step S122.

At step S122, the image transmission unit 115 of the transmission apparatus 100 decides whether the entire image input from the scope setting unit 114 was set as the copyright protection application scope by the scope setting unit 114. If the entire image is set as the copyright protection application scope, the processing proceeds to step S123. If the entire image is not set as the copyright protection application scope, that is, if the copyright protection application scope is null, the processing proceeds to step S124. At step S123, the image transmission unit 115 of the transmission apparatus 100 does not transmit the image input by the scope setting unit 114 to the receiving apparatus 200. At step S124, the image transmission unit 115 of the transmission apparatus 100 transmits the image input from the scope setting unit 114 to the receiving apparatus 200 as an image of the transmission scope.

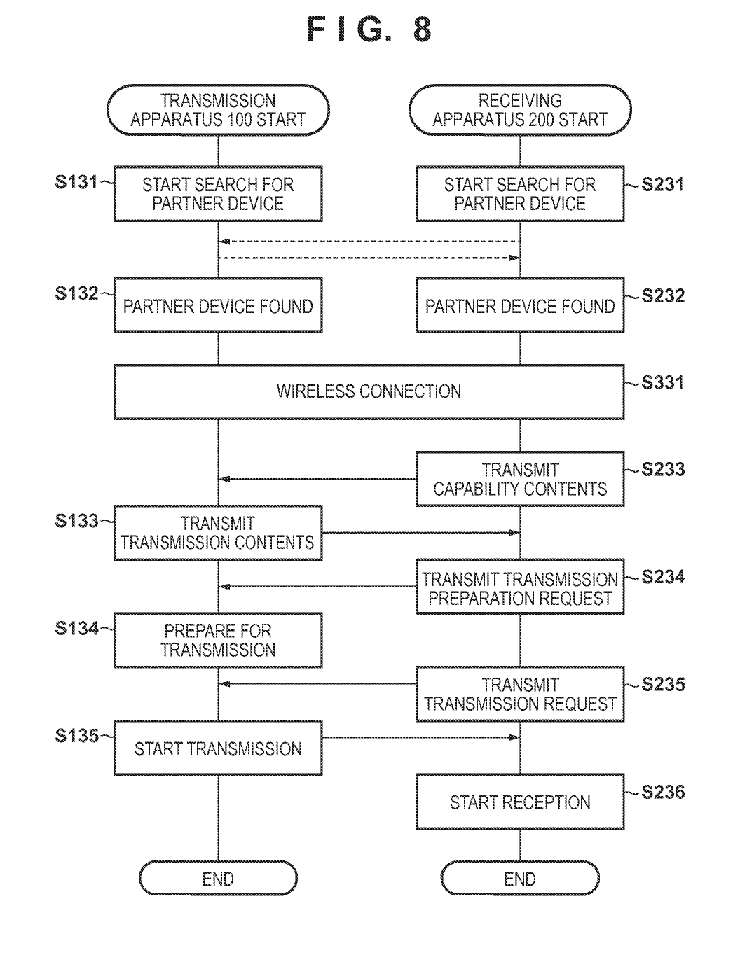

FIG. 8 is a diagram showing an exemplary sequence from when a connection between the transmission apparatus 100 and the receiving apparatus 200 is started until when image transmission is started. In FIG. 8, the steps are shown in chronological order from top to bottom. At steps S131 and S231, the transmission apparatus 100 and the receiving apparatus 200 respectively start a search for an apparatus to serve as a connection destination. At step S132, the transmission apparatus 100 finds the receiving apparatus 200. At step S232, the receiving apparatus 200 finds the transmission apparatus 100. At step S331, the transmission apparatus 100 and the receiving apparatus 200 start a wireless communication connection.

After the wireless communication connection is started at step S331, the receiving apparatus 200, at step S233, transmits information on images to the transmission apparatus 100. The information on images is, as described above, the decryption method of images, and the like. When the receiving apparatus 200 is a decryption apparatus that supports HDCP, the fact that HDCP is supported is included in the information on images that is transmitted. When the receiving apparatus 200 is not a decryption apparatus that supports HDCP, the fact that HDCP is not supported is included in the information on images that is transmitted. In the present embodiment, the receiving apparatus 200 is assumed to not be a decryption apparatus that supports HDCP. That is, in the present embodiment, the receiving apparatus transmits information on images that includes the fact that HDCP is not supported to the transmission apparatus 100.

At step S133, the transmission apparatus 100 transmits information on an image to be transmitted by the transmission apparatus 100 (method decryptable by the receiving apparatus 200) to the receiving apparatus 200, based on the acquired information on images of the receiving apparatus 200. Since the receiving apparatus 200 of the present embodiment does not support HDCP, a method that can be decrypted by the receiving apparatus 200 is designated in the information on the image to be transmitted, without designating HDCP as an encryption method. In the present embodiment, the information on the image to be transmitted by the transmission apparatus 100 designates that the image is not encrypted.

At step S234, the receiving apparatus 200 requests the transmission apparatus 100 to prepare to transmit the image. This request is realized by the receiving apparatus 200 transmitting an RTSP SETUP request message to the transmission apparatus 100. At step S134, the transmission apparatus 100 receives the image transmission preparation request of step S234, and prepares to transmit the image to the receiving apparatus 200. Also, in response to the RTSP SETUP request message of step S234, the transmission apparatus 100 transmits an RTSP SETUP response message indicating OK to the receiving apparatus 200. At step S235, the receiving apparatus 200 requests the transmission apparatus 100 to transmit the image. This request is realized by the receiving apparatus 200 transmitting an RTSP PLAY request message to the transmission apparatus 100.

At step S135, the transmission apparatus 100 receives the image transmission request of step S235, and transmits the image to the receiving apparatus 200. This image transmission is realized using RTP. Also, in response to the RTSP PLAY request message of step S235, the transmission apparatus 100 transmits an RTSP PLAY response message indicating OK to the receiving apparatus 200. Step S236 shows that the receiving apparatus 200 has started receiving the image.

With the above steps, a connection between the transmission apparatus 100 and the receiving apparatus 200 is started, and image transmission is started. Since the receiving apparatus 200 does not, however, support HDCP in the present embodiment, image transmission by the transmission apparatus 100 is clearly unlikely to be performed in step S135, in accordance with the flowchart shown in FIG. 7. At this time, the transmission apparatus 100 does not need to transmit the RTSP PLAY response message indicating OK in response to the transmission request from the receiving apparatus 200 in step S235.

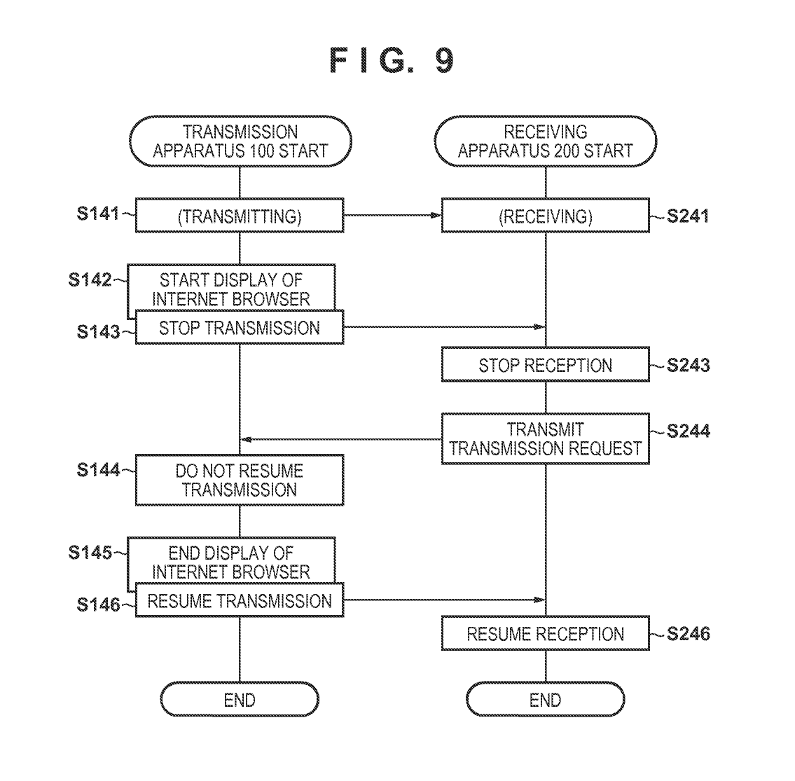

FIG. 9 is a diagram showing an exemplary sequence that includes image transmission to the receiving apparatus 200 being stopped by the transmission apparatus 100 according to the actions of the scope setting unit 114. Steps S141 and S241 show the transmission apparatus 100 and the receiving apparatus 200 transmitting and receiving an image. In step S142, the transmission apparatus 100 starts display by launching an Internet browser, for example. The Internet browser is displayed by an operation of the user of the transmission apparatus 100. Alternatively, the transmission apparatus 100 may display the Internet browser automatically rather than by a user operation. Note that it is assumed that the Internet browser is not included in the authorization list that is held by the scope setting unit 114 of the transmission apparatus 100. Note that the authorization list is a list that contains applications that do not require copyright protection, as described above. At this time, the scope setting unit 114 of the transmission apparatus 100 sets the entire input image as the copyright protection application scope.

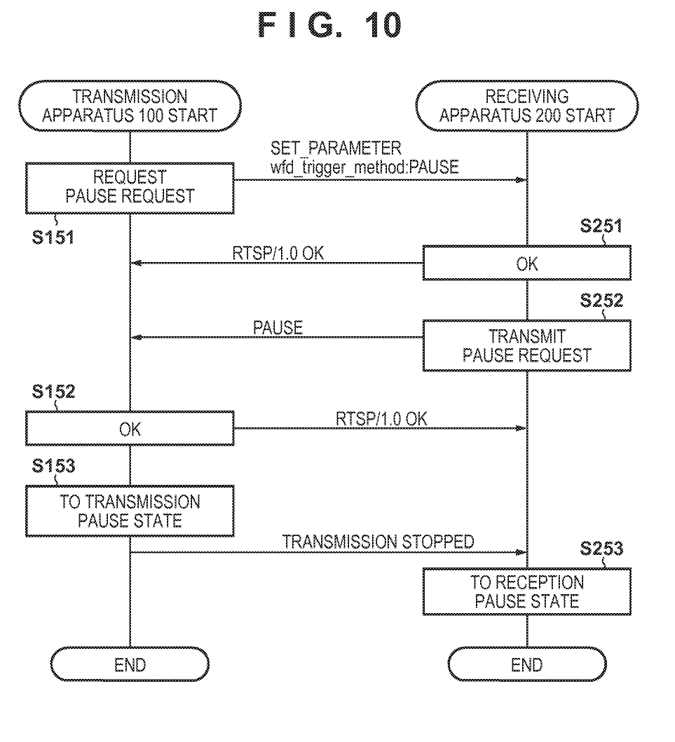

At step S143, the transmission apparatus 100 stops image transmission to the receiving apparatus 200, since the entire image input to the image transmission unit 115 is set as the copyright protection application scope. Step S143 is immediately executed as soon as step S142 has been executed. In the present embodiment, the transmission apparatus 100 stops image transmission by transmitting an RTSP PAUSE request message request to the receiving apparatus 200. The details of step S143 using RTSP will be discussed later using FIG. 10. Note that the transmission apparatus 100 may unilaterally stop image transmission over RTP, instead of stopping image transmission using RTSP. Also, the transmission apparatus 100 may display a message on the display unit 102 indicating that image transmission will be stopped. Step S243 shows that image reception stops in the receiving apparatus 200.

At step S244, the receiving apparatus 200 is able to transmit an image transmission request to the transmission apparatus 100, through transmission of an RTSP PLAY request message. In the case where the receiving apparatus 200 transmits a transmission request at step S244, the transmission apparatus 100, at step S144, transmits a PLAY response message that includes a code 465 indicating reason unknown to the receiving apparatus 200 in response to the request. Alternatively, the transmission apparatus 100 may transmit a PLAY response message that includes a different code. Alternatively, the transmission apparatus 100 may disregard the transmission request from the receiving apparatus 200. Alternatively, in the case where the transmission apparatus 100 performs multicasting, the transmission apparatus 100 may reject a request from the receiving apparatus 200 to join the multicast group.

At step S145, the transmission apparatus 100 ends display by closing the Internet browser, for example. Here, display is ended by an operation of the user of the transmission apparatus 100. However, the transmission apparatus 100 may, alternatively, end display of the Internet browser automatically, rather than by a user operation. At this time, the scope setting unit 114 of the transmission apparatus 100 sets the copyright protection application scope for the input image to null. At step S146, the transmission apparatus 100 resumes image transmission to the receiving apparatus 200. In the present embodiment, the transmission apparatus 100 resumes image transmission by transmitting an RTSP PLAY request message request to the receiving apparatus 200. Since the details of step S146 using RTSP are similar to step S143, description thereof will be omitted. Note that the transmission apparatus 100 unilaterally resumes image transmission over RTP at step S146, in the case where image transmission over RTP was unilaterally stopped at step S143. Step S246 shows that image reception is resumed by the receiving apparatus 200.

With the above steps, the transmission apparatus 100 stops and resumes image transmission to the receiving apparatus 200 according to the actions of the scope setting unit 114. In the above steps, starting and ending display of an Internet browser of the transmission apparatus 100 respectively trigger stoppage and resumption of image transmission to the receiving apparatus 200, but the present invention is not limited thereto. A similar sequence can be obtained, even when starting and ending display of video content that is protected by some form of copyright protection are respectively implemented, instead of starting and ending display of an Internet browser of the transmission apparatus 100. Alternatively, a similar sequence can be obtained, even when an operation for setting the copyright protection application scope to other than null and an operation for setting the copyright protection application scope to null are respectively implemented, instead of starting and ending display of an Internet browser.

FIG. 10 is a diagram showing an exemplary detailed sequence of steps S143 and S243, described using FIG. 9, of the transmission apparatus 100 and the receiving apparatus 200 according to the present embodiment. At step S151, the transmission apparatus 100 transmits an RTSP SET_PARAMETER request message in which the value of a wfd_trigger_method parameter is designated as PAUSE to the receiving apparatus 200. This request message requests the receiving apparatus 200 to transmit a PAUSE request message. At step S251, the receiving apparatus 200, having received this request message, transmits an RTSP SET_PARAMETER response message indicating OK to the transmission apparatus 100. At step S252, the receiving apparatus 200 transmits an RTSP PAUSE request message to the transmission apparatus 100. At step S152, the transmission apparatus 100, having received the PAUSE request message, transmits an RTSP PAUSE response message indicating OK to the receiving apparatus 200. At step S153, the transmission apparatus 100 stops image transmission over RTP. Step S253 shows that image reception has stopped in the receiving apparatus 200.

As described above, the transmission apparatus 100 according to the present embodiment stops image transmission to the receiving apparatus 200 automatically, when a screen that is to be copyright protected is displayed on the display unit 102 of the transmission apparatus. The transmission apparatus 100 then resumes image transmission to the receiving apparatus 200 automatically, when a screen that is to be copyright protected is not displayed on the display unit 102 of the transmission apparatus. According to such a configuration, image transmission can be resumed automatically without time or effort on the part of the user, even after image transmission has been interrupted owing to a lack of capability in the receiving apparatus 200.

Also, according to such a configuration, the transmission apparatus 100 is able to determine whether to perform image transmission to a plurality of receiving apparatuses 200 that are connected to the transmission apparatus 100, according to the capability of each receiving apparatus 200. That is, the transmission apparatus 100 is capable of favorable image transmission control, even with a mode of connection in which there are both receiving apparatuses that support copyright protection technology and the receiving apparatuses that do not support copyright protection technology. Also, according to such a configuration, images that are displayed on the display unit 102 of the transmission apparatus 100 are not affected by the capability of connected receiving apparatuses. Accordingly, the user of the transmission apparatus 100 is able to operate the transmission apparatus 100, regardless of the capability of connected receiving apparatuses.

### Embodiment 2

In Embodiment 1, a transmission apparatus that stops image transmission to a receiving apparatus automatically when a screen that is to be copyright protected is displayed on a display unit of the transmission apparatus, and resumes image transmission automatically when a screen that is to be copyright protected is not displayed was described. In the present embodiment, a transmission apparatus that changes the image that is displayed on a display unit of the transmission apparatus and is to be transmitted to a receiving apparatus, according to the area that is to be copyright protected will be described.

FIG. 1 is a diagram showing the mode of connection between a transmission apparatus 100 and a receiving apparatus 200 according to the present embodiment. Also, FIG. 2 is a diagram showing an exemplary internal configuration of the transmission apparatus 100. Since these constituent elements are similar to Embodiment 1, description thereof will be omitted.

FIG. 3 is a functional block diagram of the transmission apparatus 100. The constituent elements of FIG. 3 represent functional modules that are executed by the control unit 105 controlling the respective constituent elements of the transmission apparatus 100. Some or all of the constituent elements shown in FIG. 3 may be executed by hardware that is independent of the control unit 105. Since the communication control unit 111, the decision unit 112 and the display capture unit 113 are similar to Embodiment 1, description thereof will be omitted.

The scope setting unit 114 sets a scope to which copyright protection is to be applied with respect to an image or information input from the display capture unit 113, and outputs the set scope to the later-discussed image transmission unit 115 together with the input image. The scope setting unit 114 sets the copyright protection application scope to null, when it is decided by the decision unit 112 that the receiving apparatus 200 supports HDCP. When it is decided by the decision unit 112 that the receiving apparatus 200 supports HDCP, copyright protection processing on the image will likely be executed by the later-discussed image transmission unit 115. The scope setting unit 114 sets the copyright protection application scope, when it is decided by the decision unit 112 that the receiving apparatus 200 does not support HDCP. When the input image includes an object that is to be copyright protected, the scope setting unit 114 sets the display area of the object as the copyright protection application scope. When video content being displayed is protected by some form of copyright protection, the scope setting unit 114 decides, for example, that the video content being displayed is an object that is to be copyright protected. The scope setting unit 114 holds, for example, an authorization list containing applications that do not require copyright protection. When an application that has been run and is being displayed is not included in the authorization list, the scope setting unit 114 decides, for example, that the application being displayed is an object that is to be copyright protected. The authorization list may be held in the receiving apparatus 200 in advance, and may be updated when a user operation is performed or when an application is added or updated.

The image transmission unit 115 determines the transmission scope of the image input from the scope setting unit 114, based on the copyright protection application scope thereof, and transmits an image of the determined transmission scope to the receiving apparatus 200. The image transmission unit 115 substitutes a dummy image for the copyright protection application scope if the copyright protection application scope has been set in the image, and transmits the image after substitution to the receiving apparatus 200 as an image of the transmission scope. The image transmission unit 115 encrypts the image before image transmission, in accordance with the method of encrypting images to be transmitted that the communication control unit 111 transmitted to the receiving apparatus 200 in advance. In the present embodiment, image transmission uses the Real-time Transport Protocol (RTP).

FIG. 4 shows an exemplary image that is displayed on the display unit 102 by the transmission apparatus 100. The area 121 shows the entire area of the image that is displayed on the display unit 102 by the transmission apparatus 100. The area 122 is a portion of the image that is displayed on the display unit 102 by the transmission apparatus 100. The area 122 is an area in which a video playback application currently running on the transmission apparatus 100 is displayed. The area 122 may or may not include the portion that reads “Video playback application”. In the area 122, a part that is 1 minute 20 seconds into the video content is being played. The area 123 is a portion of the image that is displayed on the display unit 102 by the transmission apparatus 100. The area 123 is an area in which an Internet browser application currently running on the transmission apparatus 100 is displayed. For example, the scope setting unit 114 sets the area 122 as the copyright protection application scope, when the video content that is currently displayed by the video playback application currently displayed in the area 122 is copyright protected. For example, the scope setting unit 114 sets the area 123 as the copyright protection application scope, when the Internet browser application currently displayed in the area 123 is not included in the authorization list.

FIG. 5 is a diagram showing the internal configuration of the receiving apparatus 200 according to the present embodiment. Also, FIG. 6 is a diagram showing functional blocks of the receiving apparatus 200 according to the present embodiment. Since these constituent elements are similar to Embodiment 1, description thereof will be omitted.

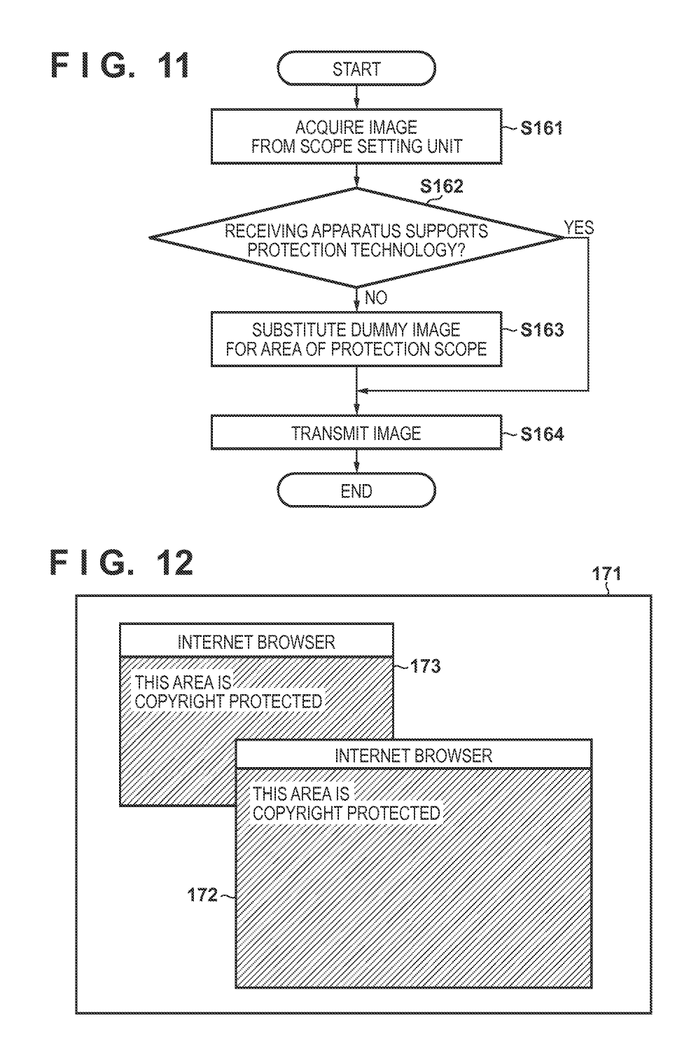

FIG. 11 is a diagram showing an exemplary flowchart from when the transmission apparatus 100 according to the present embodiment changes the transmission image until when the transmission apparatus 100 transmits the image. The steps shown in FIG. 11 are processed by the control unit 105 of the transmission apparatus 100 executing a program stored in the storage unit 104. First, at step S161, the image transmission unit 115 of the transmission apparatus 100 acquires and holds the image input from the scope setting unit 114. At step S162, the decision unit 112 of the transmission apparatus 100 decides whether the receiving apparatus 200 is a decryption apparatus that supports HDCP. If the receiving apparatus is a decryption apparatus that supports HDCP, the processing proceeds to step S164. If the receiving apparatus is not a decryption apparatus that supports HDCP, the processing proceeds to step S163. At step S163, the image transmission unit 115 of the transmission apparatus 100 substitutes a dummy image for the area of the held image that was set as the copyright protection application scope by the scope setting unit 114. In the present embodiment, the dummy image used is a black screen containing the wording “This area is copyright protected”, but the present embodiment is not limited thereto. An image prepared in advance may be used as the dummy image. At step S164, the image transmission unit 115 of the transmission apparatus 100 transmits the held image to the receiving apparatus 200.

FIG. 12 shows an exemplary image that is transmitted to the receiving apparatus 200 by the transmission apparatus 100 according to the present embodiment, when the image described using FIG. 4 is displayed on the display unit 102. An area 171 shows the entire area of the image that is transmitted to the receiving apparatus 200 by the transmission apparatus 100. The area 172 is an area obtained after the scope setting unit 114 has substituted a dummy image for the area 122 in which the video playback application of FIG. 4 is currently displayed. The video content currently displayed by this video playback application is, however, protected by some form of copyright protection. An area 173 is an area obtained after the scope setting unit 114 has substituted a dummy image for the area 123 in which the Internet browser application of FIG. 4 is currently displayed. This Internet browser application is, however, not included in the authorization list that is held by the scope setting unit 114.

FIG. 8 is a diagram showing an exemplary sequence from when a connection between the transmission apparatus 100 and the receiving apparatus 200 is started until when image transmission is started. Since the description of each step is similar to Embodiment 1, description thereof will be omitted. Note that, in the present embodiment, the receiving apparatus 200 is assumed to not be a decryption apparatus that supports HDCP, similarly to Embodiment 1.

With the above steps, a connection between the transmission apparatus 100 and the receiving apparatus 200 is started, and image transmission is started. Since the receiving apparatus 200 does not, however, support HDCP in the present embodiment, the image that is transmitted by the transmission apparatus 100 in step S135 is clearly likely to have an area substituted for a dummy image, in accordance with the flowchart shown in FIG. 11.

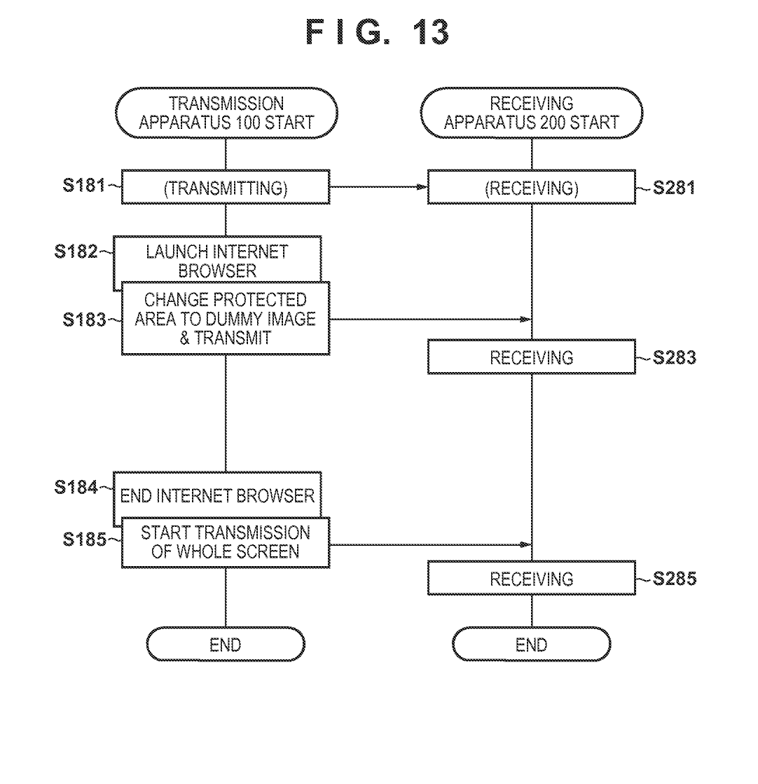

FIG. 13 is a diagram showing an exemplary sequence, including the transmission apparatus 100 according to the present embodiment changing and transmitting an image to be transmitted to the receiving apparatus 200, according to the copyright protection application scope that the scope setting unit 114 sets. Steps S181 and S281 show the transmission apparatus 100 and the receiving apparatus 200 transmitting and receiving an image. In step S182, the transmission apparatus 100 starts display by launching an Internet browser, for example. This is displayed by an operation of the user of the transmission apparatus 100. Alternatively, the transmission apparatus 100 may display the Internet browser automatically. Note that it is assumed that the Internet browser is not included in the authorization list that is held by the scope setting unit 114 of the transmission apparatus 100. At this time, the scope setting unit 114 of the transmission apparatus 100 adds the area, of the input image, in which the Internet browser is displayed to the copyright protection application scope.

At step S183, the transmission apparatus 100 substitutes a dummy image for the copyright protection application scope of the image input to image transmission unit 115, and transmits the image after substitution to the receiving apparatus 200. The display area of the Internet browser whose display was started at step S182 is included in this copyright protection application scope. Step S183 is immediately executed as soon as step S182 has been executed. Step S283 shows the image that was partially substituted for a dummy image by the transmission apparatus 100 being received by the receiving apparatus 200.

In step S184, the transmission apparatus 100 ends display by closing the Internet browser, for example. Here, display is ended by an operation of the user of the transmission apparatus 100. However, the transmission apparatus 100 may, alternatively, end display of the Internet browser automatically. At this time, the scope setting unit 114 of the transmission apparatus 100 sets the copyright protection application scope of the input image so as to remove the area added at step S182.

At step S185, the transmission apparatus 100 substitutes a dummy image for the copyright protection application scope of the image input to image transmission unit 115, and transmits the image after substitution to the receiving apparatus 200. This copyright protection application scope does not include the display area of the Internet browser whose display was started at step S182. Step S285 shows the image that was partially substituted for a dummy image by the transmission apparatus 100 being received by the receiving apparatus 200.

With the above steps, the transmission apparatus 100 changes and transmits the image to be transmitted to the receiving apparatus 200, according to the copyright protection application scope that is set by the scope setting unit 114. In the above steps, starting and ending display of an Internet browser of the transmission apparatus 100 respectively trigger stoppage and resumption of image transmission to the receiving apparatus 200, but the present invention is not limited thereto. A similar sequence can be obtained, even when starting and ending display of video content that is protected by some form of copyright protection are respectively implemented, instead of starting and ending display of an Internet browser of the transmission apparatus 100. Alternatively, a similar sequence can be obtained, even when an operation for changing the copyright protection application scope is implemented, instead of both starting and ending display of an Internet browser of the transmission apparatus 100.

As described above, when there is an area that is to be copyright protected on the screen currently displayed on the display unit 102, the transmission apparatus 100 according to the present embodiment substitutes a dummy image for this area automatically, and transmits the image to the receiving apparatus 200. According to such a configuration, it is possible, with respect to an image to be transmitted to the receiving apparatus 200 by the transmission apparatus 100, to continuously transmit only the area of the image that can be received by the receiving apparatus 200, and to maintain the benefits of image transmission as much as possible.

Although HDCP was used as copyright protection technology in the abovementioned embodiments, the present invention is not limited to HDCP, and other similar copyright protection technology generically known as Digital Transmission Content Protection (DTCP) and Digital Rights Management (DRM) may be used. Also, although RTP was used as the data transport protocol in the abovementioned embodiments, the present invention is not limited to RTP, and use of other protocols on the same layer or on different layers of the OSI reference model, such as HTTP, HTTPS and TCP, is possible. Also, although an example using RTSP as the playback control protocol was described in the abovementioned embodiment, use of playback control protocols other than RTSP such as Session Initiation Protocol (SIP) and Simple Object Access Protocol (SOAP) is also possible.

Although embodiments have been described in detail above, the present invention can be embodied as a system, an apparatus, a method, a program, a recording medium (storage medium) or the like. Specifically, the present invention may be applied to a system that is constituted by a plurality of devices (e.g., a host computer, interface device, imaging apparatus, Web application, etc.), or may be applied to an apparatus consisting of a single device.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-064348, filed Mar. 26, 2014 which is hereby incorporated by reference herein in its entirety.

What is claimed is:

1. A transmission apparatus comprising:
a display unit;
a decision unit configured to decide whether a receiving apparatus supports predetermined copyright protection technology;
a setting unit configured to set, with respect to an image that is displayed on the display unit, a scope of the image to serve as a target for copyright protection;
a determination unit configured to determine a scope of the image to serve as a target for transmission, based on the scope set as a target for copyright protection by the setting unit, in a case where it is decided by the decision unit that the receiving apparatus does not support the predetermined copyright protection technology; and
a transmission unit configured to transmit an image of the scope determined by the determination unit as a target for transmission to the receiving apparatus.

2. The transmission apparatus according to claim 1, wherein in a case where the scope serving as the target for copyright protection has been set by the setting unit in the image that is displayed on the display unit, the determination unit determines a portion of the image that is not the scope serving as the target for copyright protection as the scope serving as the target for transmission.

3. The transmission apparatus according to claim 1, wherein in a case where the whole image that is displayed on the display unit is set by the setting unit as the scope serving as the target for copyright protection, the transmission unit does not transmit the image that is displayed on the display unit.

4. The transmission apparatus according to claim 1, wherein the setting unit sets, with respect to an image that is displayed on the display unit, a scope of the image that includes a predetermined object, as the scope serving as the target for copyright protection.

5. The transmission apparatus according to claim 1, wherein the setting unit sets, with respect to an image that is displayed on the display unit, a scope of the image that is displayed by a predetermined application, as the scope serving as the target for copyright protection.

6. The transmission apparatus according to claim 1, wherein in a case where the image that is displayed on the display unit includes a predetermined object or includes a scope that is displayed by a predetermined application, the setting unit sets the entire image as the scope serving as the target for copyright protection.

7. The transmission apparatus according to claim 1, wherein in a case where the scope serving as the target for copyright protection has been set by the setting unit in the image that is displayed on the display unit, the determination unit substitutes a dummy image for an image of the scope serving as the target for copyright protection, and determines the entire image that is displayed on the display unit after the substitution as the scope serving as the target for transmission.

8. The transmission apparatus according to claim 1, wherein the transmission unit does not transmit an image of a scope that is not the scope serving as the target for transmission, even when an image transmission request is received from the receiving apparatus.

9. The transmission apparatus according to claim 1, wherein in a case where the scope serving as the target for copyright protection is set by the setting unit with respect to the receiving apparatus in the image that is displayed on the display unit, the transmission unit causes the receiving apparatus to resign from a multicast group.

10. The transmission apparatus according to claim 1, wherein in a case where the scope serving as the target for copyright protection is not set by the setting unit in the image that is displayed on the display unit, the transmission unit causes the receiving apparatus to join a multicast group.

11. The transmission apparatus according to claim 1, wherein the transmission unit performs transmission to the receiving apparatus based on Real Time Streaming Protocol (RTSP).

12. The transmission apparatus according to claim 11, wherein in a case where the entire image that is displayed on the display unit is set by the setting unit as the scope serving as the target for copyright protection, the transmission unit transmits a PAUSE request message.

13. The transmission apparatus according to claim 1, wherein the transmission unit communicates over Real-time Transport Protocol (RTP) with the receiving apparatus.

14. The transmission apparatus according to claim 13, wherein in a case where the entire image that is displayed on the display unit is set by the setting unit as the scope serving as the target for copyright protection, the transmission unit stops data transmission over RTP.

15. The transmission apparatus according to claim 1, wherein the predetermined copyright protection technology is High-bandwidth Digital Content Protection (HDCP).

16. A method of controlling a transmission apparatus having a display unit, comprising:
a decision step of deciding whether a receiving apparatus supports predetermined copyright protection technology;
a setting step of setting, with respect to an image that is displayed on the display unit, a scope of the image to serve as a target for copyright protection;
a determination step of determining a scope of the image to serve as a target for transmission, based on the scope set as a target for copyright protection in the setting step, in a case where it is decided in the decision step that the receiving apparatus does not support the predetermined copyright protection technology; and
a transmission step of transmitting an image of the scope determined in the determination step as a target for transmission to the receiving apparatus.

17. A non-transitory computer-readable storage medium storing a computer program for controlling a computer to execute respective steps of claim 16.
